(19) United States
(12) Patent Application Publication
(10) Pub. No.: US 2016/0344029 A1
(43) Pub. Date: Nov. 24, 2016

(54) ELECTRODE MATERIAL, METHOD OF MANUFACTURING ELECTRODE MATERIAL, ELECTRODE, AND LITHIUM ION SECONDARY BATTERY

(71) Applicant: Sumitomo Osaka Cement Co., Ltd, Tokyo (JP)

(72) Inventors: Hirofumi YASUMIISHI, Yachiyo-shi (JP); Ryuuta YAMAYA, Narashino-shi (JP)

(21) Appl. No.: 14/936,901

(22) Filed: Nov. 10, 2015

(30) Foreign Application Priority Data
May 21, 2015 (JP) 2015-103663

(51) Int. Cl. H01M 4/58; H01M 4/136; H01M 4/1397; H01M 10/0525

(52) U.S. Cl. CPC H01M 4/58; H01M 10/0525; H01M 4/136; H01M 4/1397; H01M 2004/021

(57) ABSTRACT

An electrode material includes electrode material primary particles including first electrode material primary particles having a particle size in a range of 400 nm to 900 nm, and second electrode material primary particles having a particle size in a range of equal to or greater than 300 nm and less than 400 nm. In a case where the number of the first electrode material primary particles is set as A, and the number of the second electrode material primary particles is set as B when observing a visual field of the electrode material in a range of 3.0 μm×2.4 μm at a magnification of 30,000 times by using a scanning electron microscope, a value of B/A is 3 to 12. A method of manufacturing an electrode material includes mixing two or more kinds of electrode material primary particles having average particle sizes different from each other.

### BACKGROUND OF THE INVENTION

1. Field of the Invention

The present invention relates an electrode material for a lithium ion secondary battery, a method of manufacturing the electrode material, an electrode including the electrode material, and a lithium ion secondary battery using the electrode as a positive electrode.

2. Description of Related Art

Recently, technological development of clean energy has rapidly progressed, and it is necessary to create an environment, which is considerate of the earth, such as an environment with non-dependency on oil, zero emissions, and the spread of power saving products. Particularly, recently, a large-capacity storage battery that supplies electric energy to an electric vehicle, a large-capacity storage battery that supplies electric energy in case of an emergency or in a case where disasters occur, and a secondary battery that supplies electric energy to a portable information apparatus, a portable information terminal, and the like have been in the spotlight. As the storage battery and the secondary battery, for example, a lead storage battery, an alkali storage battery, a lithium ion secondary battery, and the like are known. Particularly, the lithium ion secondary battery is capable of realizing a reduction in size, a reduction in weight, and high capacity, and has excellent characteristics such as a high output and a high energy density. Accordingly, the lithium ion secondary battery has been commercialized as a high-output power supply of an electric vehicle, an electromotive tool, and the like, and development of a material for a next generation lithium ion secondary battery has been actively in progress in the world.

In addition, recently, as a collaboration between the large-capacity storage battery that supplies electric energy and a house, a home energy management system (HEMS) has attracted attention. The HEMS is a system that wisely consumes energy through management of automatic control, optimization of electric power supply and demand, and the like by integrating information relating to home electricity in the smart home appliance, the electric vehicle, solar cell power generation, and the like, and a control system.

As an electrode active material, which is used in a positive electrode of a lithium ion secondary battery that is put into practical use, generally, LiCoO₂ and LiMnO₂ have been used. However, Co is unevenly distributed on the earth, and is a rare resource. Accordingly, there is a concern that the product cost of the lithium ion secondary battery becomes high in consideration of a large amount of use, and thus it is difficult to stably supply Co. Here, research and development of a positive electrode active material such as spinel system LiMn₂O₄, ternary system LiNi_{1/3}Mn_{1/3}CO_{1/3}O₂, lithium iron oxide (LiFeO₂), and lithium iron phosphate (LiFePO₄) as a positive electrode active material, which substitute for LiCoO₂, have been actively in progress. Among these positive electrode materials, LiFePO₄, which has an olivine structure, has attracted attention as a positive electrode material with no problem relating to stability, resources, and cost. The olivine system positive electrode material, which is represented by LiFePO₄, contains phosphorus as a constituent element, and phosphorous and oxygen have a strong covalent bond. Accordingly, when being compared to a positive electrode material such as LiCoO₂, there is no concern of emission of oxygen at a high temperature, and there is no concern of firing risk due to oxidative decomposition of an electrolytic solution. As a result, it can be said that LiFePO₄ is a material excellent in stability.

However, even in LiFePO₄ having the above-described advantages, there is a problem with low electron conductivity. This problem is considered due to slowness in diffusion of lithium ions at the inside of an active material and low electron conductivity which are derived from a structure. Accordingly, as an electrode material in which electron conductivity is improved, for example, there is suggested an electrode material including an electrode active material having an olivine structure that is expressed by LiₓA_{y}D_{z}PO₄ (provided that, A represents one or more kinds selected from the group consisting of Co, Mn, Ni, Fe, Cu, and Cr, D represents one or more kinds selected from the group consisting of Mg, Ca, Sr, Ba, Ti, Zn, B, Al, Ga, In, Si, Ge, Sc, Y, and a rare earth element, and relationships of 0<x≦2, 0≦y≦1.5, and o≦z≦1.5 are satisfied) (for example, refer to Japanese Laid-open Patent Publication No. 2011-216233).

### SUMMARY OF THE INVENTION

However, recently, even in the electrode material of the lithium ion secondary battery, there is a demand for an improvement in additional high-rate characteristics, and particularly, there is a demand for a reduction in DC resistance (DCR). This is also demanded for an electrode material including an electrode active material having an olivine structure. In addition, an improvement in a capacity retention rate during charge and discharge of the lithium ion secondary battery for a long period of time is preferable for the electrode material including the electrode active material having the olivine structure. Accordingly, an object of the invention is to provide an electrode material capable of preparing a lithium ion secondary battery in which DC resistance (DCR) is low, and which can maintain a high capacity retention rate for a long period of time, a method of manufacturing the electrode material, an electrode including the electrode material, and a lithium ion secondary battery including the electrode as a positive electrode.

The present inventors have made a thorough investigation. As a result, they found that when a ratio of the number of particles between electrode material primary particles having a particle size in a range of 400 nm to 900 nm, and electrode material primary particles having a particle size in a range of equal to or greater than 300 nm and less than 400 nm is set in a predetermined range in an electrode material, the DC resistance (DCR) of the lithium ion secondary battery decreases, and the high capacity retention rate of the lithium ion secondary battery can be maintained for a long period of time, and they accomplished the invention. That is, the present invention is as follows.

[1] According to an aspect of the invention, there is provided an electrode material including electrode material primary particles. The electrode material primary particles include electrode active material primary particles which include LiFeₓM_{y}Mn_{1-x-y}PO₄ (provided that, M represents one or more kinds selected from the group consisting of Mg, Ca, Co, Sr, Ba, Ti, Zn, B, Al, Ga, In, Si, Ge, and a rare earth element, and relationships of 0≦x≦1 and 0≦y≦0.14 are satisfied) and have an olivine structure, and a carbonaceous film that covers the surface of the electrode active material primary particles. The electrode material primary particles include first electrode material primary particles having a particle size in a range of 400 nm to 900 nm, and second electrode material primary particles having a particle size in a range of equal to or greater than 300 nm and less than 400 nm. In a case where the number of the first electrode material primary particles is set as A and the number of the second electrode material primary particles is set as B when observing a visual field of the electrode material in a range of 3.0 μm×2.4 μm at a magnification of 30,000 times by using a scanning electron microscope, a value of B/A is 3 to 12.

[2] In the electrode material according to [1], the value of B/A may be 5 to 11.

[3] In the electrode material according to [1], the value of B/A may be 3 to 8.

[4] In the electrode material according to any one of [1] to [3], electrode material primary particles having a particle size of 1100 nm or greater may not be included.

[5] According to another aspect of the invention, there is provided a method of manufacturing an electrode material. The method includes mixing two or more kinds of electrode material primary particles having average particle sizes different from each other to manufacture the electrode material according to any one of [1] to [4].

[6] According to still another aspect of the invention, there is provided an electrode containing the electrode material according to any one of [1] to [4], or the electrode material that is manufactured in accordance with the method of manufacturing of the electrode material according to [5].

[7] According to still another aspect of the invention, there is provided a lithium ion secondary battery including the electrode according to [6] as a positive electrode.

[8] In the lithium ion secondary battery according to [7], DC resistance (DCR) on an output side may be 520 Ω·mg or less, and a capacity retention rate at a 300^{th} cycle may be 75% or greater.

According to the invention, it is possible to provide an electrode material capable of preparing a lithium ion secondary battery in which DC resistance (DCR) is low, and which can maintain a high capacity retention rate for a long period of time, a method of manufacturing the electrode material, an electrode including the electrode material, and a lithium ion secondary battery including the electrode as a positive electrode.

### DETAILED DESCRIPTION OF THE INVENTION

Electrode Material

An electrode material of the invention includes electrode material primary particles. In addition, the electrode material of the invention further includes a conductive auxiliary agent. Hereinafter, the electrode material of the invention will be described in detail. In addition, in the electrode material of the invention, the amount of the electrode material primary particles which are contained in the electrode material of the invention is preferably 80% by mass or greater, more preferably 85% by mass or greater, and still more preferably 90% by mass or greater.

Electrode Material Primary Particles

The electrode material primary particles which are used in the electrode material of the invention include electrode active material primary particles, and a carbonaceous film that covers the surface of the electrode active material primary particles. The electrode material primary particles which are used in the electrode material of the invention may be present alone without being aggregated, or may be present in a state in which a plurality of electrode active material primary particles are aggregated.

The electrode material primary particles which are used in the electrode material of the invention include a plurality of first electrode material primary particles having a particle size in a range of 400 nm to 900 nm, and a plurality of second electrode material primary particles having a particle size in a range of equal to or greater than 300 nm and less than 400 nm. Here, the particle size represents a value that is measured by observing the electrode material at a magnification of 30,000 times by using a scanning electron microscope. In addition, in a case where the electrode material primary particles do not have a spherical shape, the length (major axis) of the longest line segment, among line segments across a particle along a longitudinal direction thereof, is set as the particle size of each of the electrode material primary particles.

In a case where the number of the first electrode material primary particles is set as A, and the number of the second electrode material primary particles is set as B when observing a visual field of the electrode material in a range of 3.0 μm×2.4 μm at a magnification of 30,000 times by using a scanning electron microscope, a value of B/A is 3 to 12. When the value of B/A is less than 3, in a case of preparing a lithium ion secondary battery by using an electrode material including the electrode material primary particles, output DC resistance (DCR) of the lithium ion secondary battery increases. In addition, when the value of B/A is greater than 12, in a case of preparing the lithium ion secondary battery by using the electrode material including the electrode material primary particles, a capacity retention rate of the lithium ion secondary battery after use for a long period of time significantly decreases. From the viewpoint of increasing the output DC resistance (DCR) of the lithium ion secondary battery, the value of B/A is preferably 5 to 11. In addition, from the viewpoint of further suppressing a decrease in the capacity retention rate of the lithium ion secondary battery after use for a long period of time, the value of B/A is preferably 3 to 8, and more preferably 3 to 5.

It is preferable that the electrode material primary particles, which are used in the electrode material of the invention, do not include electrode material primary particles having a particle size of 1100 nm or greater. According to this, it is possible to suppress formation of a large void between the electrode material primary particles. In addition, when the large void occurs between the electrode material primary particles, ion conductivity of the electrode material may decrease.

Electrode Active Material Primary Particles

The electrode active material primary particles, which are used in the electrode material of the invention, include LiFeₓM_{y}Mn_{1-x-y}PO₄ (provided that, M represents one or more kinds selected from the group consisting of Mg, Ca, Co, Sr, Ba, Ti, Zn, B, Al, Ga, In, Si, Ge, and a rare earth element, and relationships of 0≦x≦1 and 0≦y≦0.14 are satisfied), and has an olivine structure. According to this, it is possible to obtain a high discharge potential. In addition, examples of the rare earth element include 15 elements such as La, Ce, Pr, Nd, Pm, Sm, Eu, Gd, Tb, Dy, Ho, Er, Tm, Yb, and Lu of the lanthanide series.

An average particle size of the electrode active material primary particles is preferably 300 nm to 470 nm, more preferably 300 nm to 420 nm, and still more preferably 300 nm to 400 nm. When the average particle size of the electrode active material primary particles is 300 nm to 470 nm, a diffusion path inside an LFP solid is shortened, and thus it is possible to increase discharge capacity during high-speed charge and discharge, and it is possible to realize sufficient charge and discharge rate performance. In addition, when the average particle size of the electrode active material primary particles is 300 nm to 470 nm, ion conductivity of the electrode active material primary particles decreases, and thus it is possible to suppress the occurrence of deficient discharge capacity at a high-speed charge and discharge rate.

In addition, in the invention, the average particle size represents a particle size D50 when an accumulated volume percentage is 50% in a particle size distribution. The average particle size of the electrode active material primary particles can be calculated by selecting 500 particles in a random manner, measuring particle sizes of the electrode active material primary particles with a scanning electron microscope, and averaging the particle sizes. In addition, in a case where the electrode active material primary particles do not have a spherical shape, an average of the length (major axis) of the longest line segment among line segments across a particle, and the length (minor axis) of a line segment perpendicular to the center of the major axis among line segments across the particle is set as the particle size of each of the electrode active material primary particles.

Carbonaceous Film

The carbonaceous film covers the surface of the electrode active material primary particles, and improves the electrical conductivity of the electrode material primary particles. The thickness of the carbonaceous film is preferably 0.5 nm to 7.0 nm, and more preferably 0.5 nm to 3.0 nm. When the thickness of the carbonaceous film is 0.5 nm to 7.0 nm, it is possible to sufficiently improve the electrical conductivity of the electrode material primary particles, and it is possible to suppress a decrease in high-rate characteristics, particularly, an increase in the DC resistance (DCR) due to an obstacle during lithium diffusion which is caused by the carbonaceous film. The thickness of the carbonaceous film on the surface of the electrode material primary particles can be measured by observing the carbonaceous film by using a transmission electron microscope (TEM) and an energy-dispersive X-ray spectrometer (EDX).

A coverage ratio of the surface of the electrode active material primary particles by the carbonaceous film is preferably 80% or greater, more preferably 90% or greater, and still more preferably 95% or greater. When the coverage ratio by the carbonaceous film is 80% or greater, on the surface of the electrode active material primary particles, the coating by the carbonaceous film becomes sufficient, and thus it is possible to improve the electrical conductivity of the electrode material primary particles. As a result, discharge capacity increases at a high-speed charge and discharge rate, and thus it is possible to realize sufficient charge and discharge rate performance. The coverage ratio by the carbonaceous film on the surface of the electrode active material primary particles is obtained by observing the carbonaceous film by using the transmission electron microscope (TEM) and the energy-dispersive X-ray spectrometer (EDX), and calculating the percentage of a portion, which is covered with the carbonaceous film, on the surface of the electrode active material primary particles.

Conductive Auxiliary Agent

The conductive auxiliary agent forms a route through which electricity flows to a gap between the electrode active material primary particles. According to this, electricity flows to the gap between the electrode active material primary particles, and thus the electrical conductivity of the electrode material is improved, and as a result, it is possible to decrease the DC resistance (DCR). An average particle size of primary particles of the conductive auxiliary agent is preferably 20 nm or less, and more preferably 15 nm or less. When the average particle size of the primary particles of the conductive auxiliary agent is 20 nm or less, it is possible to fill the gap between the electrode active material primary particles with the conductive auxiliary agent. In addition, the lower limit of the average particle size of the primary particles of the conductive auxiliary agent is not particularly stated. However, the lower limit is, for example, 10 nm.

In addition, the average particle size of the primary particles of the conductive auxiliary agent can be calculated by selecting 500 particles in a random manner, measuring particle sizes of the primary particles of the conductive auxiliary agent with a scanning electron microscope, and averaging the particle sizes. In addition, in a case where the primary particles of the conductive auxiliary agent do not have a spherical shape, an average of the length (major axis) of the longest line segment among line segments across a particle, and the length (minor axis) of a line segment perpendicular to the center of the major axis among line segments across the particle is set as the particle size of each of the primary particles of the conductive auxiliary agent.

The conductive auxiliary agent is preferably a carbon material fromthe viewpoint of excellent electrical conductivity, more preferably one or more kinds selected from the group consisting of thermal black, furnace black, lamp black, acetylene black, Ketjen black, and a carbon nanotube, still more preferably one or more kinds selected from the group consisting of acetylene black and Ketjen black, and still more preferably acetylene black from the viewpoints of high purity and crystallinity, and high linkage between particles.

Method of Manufacturing Electrode Material

The method of manufacturing the electrode material of the invention is a method of manufacturing an electrode material for preparation of the electrode material of the invention, and includes a process of mixing two or more kinds of electrode material primary particles having average particle sizes different from each other. According to this, it is possible to adjust a ratio (B/A) of the number B of second electrode material primary particles having a particle size in a range of 300 nm to 400 nm to the number A of first electrode material primary particles having a particle size in a range of 400 nm to 900 nm by changing a mixing ratio between the two or more kinds of electrode material primary particles having average particle sizes different from each other. In addition, if the average particle sizes of the electrode material primary particles are different from each other, specific surface areas of the electrode material primary particles are different from each other, and thus whether or not the average particle sizes of two or more kinds of electrode material primary particles are different from each other may be evaluated using the specific surface areas of the electrode material primary particles.

For example, the electrode material primary particles, which are used in the electrode material of the invention, are prepared as follows. Particles or precursors thereof, which are composed of LiFeₓM_{y}Mn_{1-x-y}PO₄ (provided that, M represents one or more kinds selected from the group consisting of Mg, Ca, Co, Sr, Ba, Ti, Zn, B, Al, Ga, In, Si, Ge, and a rare earth element, and relationships of 0≦x≦1 and 0≦y≦0.14 are satisfied), are prepared through hydrothermal synthesis. Description will be given of a process of preparing the particles or the precursors thereof with reference to LiFePO₄ particles (provided that, x=1 and y=0) as an example.

The LiFePO₄ particles can be obtained as follows. Specifically, a Li source, an Fe source, and a P source are put into a solvent containing water as a main component in such a manner that a molar ratio (Li source:Fe source:P source) of the sources becomes 1:1:1, and the resultant mixture is stirred to obtain a precursor solution of LiFePO₄. The precursor solution is put into a pressure-resistant vessel, and a hydrothermal treatment is carried out under a high temperature and a high pressure, for example, at 120° C. to 250° C. and 0.2 MPa, and for one hour to 24 hours.

As the Li source, for example, one or more kinds selected from the group consisting of a lithium inorganic acid salt such as lithium hydroxide (LiOH), lithium carbonate (Li₂CO₃), lithium chloride (LiCl), and lithiumphosphate (Li₃PO₄), a lithiumorganic acid salt such as lithium acetate (LiCH₃COO) and lithium oxalate ((COOLi)₂), and hydrates thereof are appropriately used. Particularly, raw materials such as lithium chloride and lithium acetate, which forma uniform solution phase with the Fe source and the P source, are preferable.

As the Fe source, for example, iron compounds such as iron (II) chloride (FeCl₂), iron (II) sulfate (FeSO₄), and iron (II) acetate (Fe(CH₃COO)₂), or hydrates thereof are appropriately used.

As the P source, one or more kinds selected from the group consisting of phosphoric acids such as orthophosphoric acid (H₃PO₄) and metaphosphoric acid (HPO₃), ammonium dihydrogen phosphate (NH₄H₂PO₄), diammoniumhydrogenphosphate ((NH₄)₂HPO₄), ammonium phosphate ((NH₄)₃PO₄), and hydrates thereof are appropriately used. Particularly, the orthophosphoric acid is preferable considering that the orthophosphoric acid forms a uniform solution phase with the Li source and the P source.

In addition, as is the case with the LiFePO₄ particles, LiFeₓM_{y}Mn_{1-x-y}PO₄ particles can be obtained as follows. Specifically, a Li source, an Fe source, an M source, a Mn source, and a P source are put into a solvent containing water as a main component in such a manner that a molar ratio (Li source:Fe source:M source:Mn source:P source) of the sources becomes 1:x:y:1-x-y:1, and the resultant mixture is stirred to obtain a precursor solution of LiFeₓM_{y}Mn_{1-x-y}PO₄. The precursor solution is put into a pressure-resistant vessel, and a hydrothermal treatment is carried out at a high temperature and a high pressure, for example, at 120° C. to 250° C. and 0.2 MPa, and for one hour to 24 hours.

Next, a carbon source is added to the particles or the precursors thereof which are composed of LiFeₓM_{y}Mn_{1-x-y}PO₄ that is obtained by the hydrothermal synthesis method, and the resultant mixture is baked.

There is no particular limitation to the carbon source as long as the carbon source is an organic compound that generates carbon through a heat treatment under a non-oxidizing atmosphere. Examples of the carbon source include cellulose such as polyvinyl alcohol (PVA), polyvinyl pyrrolidinone, methyl cellulose, and ethyl cellulose, saccharides such as starch, gelatin, hyaluronic acid, glucose (D-glucose), fructose (D-fructose), sucrose, and lactose, higher monohydric alcohol such as hexanol and octanol, unsaturated monohydric alcohol such as allyl alcohol, propynol (propargyl alcohol), and terpineol, polyvinyl acetate, polyether, and the like. Particularly, glucose (D-glucose), fructose (D-fructose), and polyvinyl alcohol (PVA) are preferable when considering that a uniform solution phase can be formed during preparation of slurry.

Although not particularly limited, a concentration of the organic compound is preferably 1% by mass to 25% by mass so as to uniformly form the carbonaceous film having a predetermined thickness on the surface of the LiFeₓM_{y}Mn_{1-x-y}PO₄ particles.

Here, a predetermined amount of particles or precursors thereof which are composed of LiFeₓM_{y}Mn_{1-x-y}PO₄, and a predetermined amount of the carbon source are dispersed in water, thereby preparing slurry. As a dispersion apparatus that is used during preparation of the slurry, a wet type pulverization apparatus such as a planetary mill, a vibration mill, and a ball mill is appropriately used. The wet type pulverization apparatus can disperse the particles or the precursors thereof which are composed of LiFeₓM_{y}Mn_{1-x-y}PO₄ in water, and can pulverize the particles or the precursors thereof which are composed of LiFeₓM_{y}Mn_{1-x-y}PO₄. Accordingly, it is possible to control the average particle size of the electrode material primary particles by adjusting dispersion conditions in the wet type pulverization apparatus. Accordingly, it is possible to prepare two or more kinds of electrode material primary particles having average particle sizes different from each other by changing the dispersion conditions during preparation of the slurry of the particles or the precursors which are composed of LiFeₓM_{y}Mn_{1-x-y}PO₄ and the carbon source.

Next, the slurry, which is obtained by dispersing the predetermined amount of LiFeₓM_{y}Mn_{1-x-y}PO₄ particles or precursors thereof in water, and the predetermined amount of carbon source, is dried in air, for example, at a temperature of 70° C. to 250° C., and then, the resultant dried material is calcined under a nitrogen atmosphere at a calcination temperature of 200° C. to 300° C. for a calcination time of 30 minutes to 2 hours. According to this, a calcined component of primary particles or precursors thereof, in which the surface of the LiFeₓM_{y}Mn_{1-x-y}PO₄ particles or the precursors thereof are covered with the carbon source (organic compound), is obtained.

Next, the calcined component, which is obtained, is baked at a baking temperature of 600° C. to 1000° C. and for a baking time of 5 minutes to 40 hours in a non-oxidizing atmosphere, for example, in an inert gas atmosphere such as a nitrogen gas, or a reducing gas atmosphere in which approximately several % by volume of hydrogen gas is mixed in the nitrogen gas in a case of preventing oxidation. In addition, a burnable or combustible gas such as oxygen may be introduced to the inert atmosphere so as to remove the carbon source (organic compound) that is evaporated into the non-oxidizing atmosphere during baking.

According to this, the primary particles of LiFeₓM_{y}Mn_{1-x-y}PO₄ are generated, and the carbon source that covers the surface is carbonized and thus the carbonaceous film that covers the surface of the primary particles of LiFeₓM_{y}Mn_{1-x-y}PO₄ is formed. As described above, the electrode material primary particles are prepared.

It is possible to prepare two or more kinds of electrode material primary particles having average particle sizes different from each other by adjusting the above-described dispersion conditions during preparation of the slurry. In addition, it is possible to manufacture the electrode material of the invention by mixing the two or more kinds of electrode material primary particles having average particle sizes different from each other in a predetermined ratio. Examples of the two or more kinds of electrode material primary particles having average particle sizes different from each other include electrode material primary particles having an average particle size of 400 nm to 900 nm, and electrode material primary particles having an average particle size of equal to or greater than 300 nm and less than 400 nm. The electrode material primary particles having an average particle size of 400 nm to 900 nm include a lot of electrode material primary particles having a particle size of 400 nm to 900 nm, and the electrode material primary particles having an average particle size of equal to or greater than 300 nm and less than 400 nm include a lot of electrode material primary particles having a particle size of equal to or greater than 300 nm and less than 400 nm. Accordingly, when adjusting a mixing ratio of these electrode material primary particles, it is possible to control a value of B/A in a case where the number of the first electrode material primary particles is set as A and the number of the second electrode material primary particles is set as B when observing a visual field of the electrode material in a range of 3.0 μm×2.4 μm at a magnification of 30,000 times by using a scanning electron microscope.

Electrode and Lithium Ion Secondary Battery

The electrode of the invention includes the electrode material of the invention, or the electrode material that is manufactured by the method of manufacturing an electrode material of the invention. In addition, the lithium ion secondary battery of the invention includes the electrode of the invention as a positive electrode. Hereinafter, description will be made in detail.

When preparing the electrode of the invention, for example, the electrode material of the invention, a binding agent composed of a binder resin, and a solvent are mixed with each other to prepare electrode slurry or electrode paste. At this time, a conductive auxiliary agent such as carbon black may be added as necessary.

As the binding agent, that is, the binder resin, for example, a polytetrafluoroehtylene (PTFE) resin, a polyvindylidene fluoride (PVDF) resin, a fluorine rubber, and the like are appropriately used. A mixing ratio between the electrode material and the binder resin is not particularly limited, and for example, the binder resin is set to 1 part by mass to 30 parts by mass of binder resin on the basis of 100 parts by mass of electrode material, and preferably 3 parts by mass to 20 parts by mass.

Examples of the solvent that is used in the electrode slurry or the electrode paste include water, alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, and ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether.

In addition, examples of the solvent that is used in the electrode slurry or the electrode paste also include ketones such as acetone, methyl ethyl ketone (MEK), methyl isobutyl ketone (MIBK), acetyl acetone, and cyclohexanone, amides such as dimethyl formamide, N, N-dimethylacetoacetamide, and N-methylpyrrolidinone, glycols such as ethylene glycol, diethylene glycol, and propylene glycol, and the like. These solvents may be used alone or two or more kinds thereof may be mixed and used.

Next, the electrode slurry or the electrode paste is applied to one surface of a current collector such as metal foil, and is dried, thereby obtaining a current collector in which a film formed from a mixture of the electrode material and the binder resin is formed on one surface thereof.

Next, the film is compressed under pressure, and is dried, thereby preparing the electrode of the invention which includes a positive electrode layer on one surface of the metal foil. In addition, the electrode is set as a positive electrode, thereby obtaining the lithium ion secondary battery of the invention. In one embodiment of the lithium ion secondary battery of the invention, for example, DC resistance (DCR) on an output side is 520 Ω·mg or less, and a capacity retention rate at a 300^{th} cycle is 75% or greater.

### Examples

Hereinafter, the invention will be described in detail with reference to Examples 1 to 5, and Comparative Examples 1 to 5, but the invention is not limited to the Examples.

Evaluation Method

Electrode materials and lithium ion secondary batteries of Examples and Comparative Examples were evaluated as follows.

(1) Specific Surface Area of Electrode Material Primary Particles of Raw Material of Electrode Material

The specific surface area (BET specific surface area) of the electrode material primary particles of a raw material of the electrode material was measured by using a specific surface area meter (manufactured by MicrotracBEL Corp., model number: BellSorp-mini).

(2) Number (A) of Electrode Material Primary Particles Having Particle Size in Range of 400 nm to 900 nm in Electrode Material

A visual field of the electrode material in a range of 3.0 μm×2.4 μm was observed at a magnification of 30,000 times by using a scanning electron microscope (manufactured by Hitachi High-Technologies Corporation., model number: S-4000), and electrode material primary particles having a particle size in a range of 400 nm to 900 nm were counted. Visual fields at five sites were observed, and the average number thereof was set as the number (A) of the electrode material primary particles having a particle size in a range of 400 nm to 900 nm.

(3) Number (B) of Electrode Material Primary Particles Having Particle Size in Range of Equal to or Greater Than 300 nm and Less Than 400 nm in Electrode Material

In the same visual field as in counting of the electrode material primary particles having a particle size in a range of 400 nm to 900 nm, the electrode material primary particles having a particle size in a range of equal to or greater than 300 nm and less than 400 nm were counted. Five visual fields were observed, and the average number thereof was set as the number (B) of the electrode material primary particles having a particle size in a range of equal to or greater than 300 nm and less than 400 nm.

(4) DC Resistance (DCR)

With respect to a lithium ion secondary battery, after charge was carried out with 0.1 C at an environmental temperature of 25° C. in a state of charge (SOC) of 50%, “1 C charge for 10 seconds→Pause for 10 minutes→1 C discharge for 10 seconds→Pause for 10 minutes” as a first cycle, “3 C charge for 10 seconds→Pause for 10 minutes→3 C discharge for 10 seconds→Pause for 10 minutes” as a second cycle, “5 C charge for 10 seconds→Pause for 10 minutes→5 C discharge for 10 seconds→Pause for 10 minutes” as a third cycle, and “10 C charge for 10 seconds→Pause for 10 minutes→10 C discharge for 10 seconds→Pause for 10 minutes” as a fourth cycle were carried out in this order, and an approximate curve was drawn on the basis of numerical values after 10 seconds during each of the charge and discharge. In the approximate curve, an inclination on an output side of a straight line was set as output DC resistance (DCR).

(5) Capacity Retention Rate at 300^{th} Cycle

Discharge capacity of the lithium ion secondary battery was measured by using a discharge capacity measuring apparatus (manufactured by HOKUTO DENKO CORP., model number: HJ1010mSM8). With respect to the lithium ion secondary battery, constant current charge was carried out at 25° C. with a current value of 0.1 C until a charge voltage became 4.2 V, and the constant current charge was switched to constant voltage charge. The charge was terminated at a point of time at which a current value became 0.01 C. Then, discharge was carried out with a discharge current of 3 C, and the discharge was terminated at a point of time at which a battery voltage became 2.0 V. The charge and discharge were repeated, and 0.1 C discharge capacity at a 300^{th} cycle was measured in a state in which charge and discharge at a first time were set as a first cycle. Then, a capacity retention rate for initial capacity was calculated.

Preparation of Sample

Preparation of Electrode Material

4 moles of lithium acetate (LiCH₃COO), 2 moles of iron (II) sulfate (FeSO₄), and 2 moles of phosphoric acid (H₃PO₄) were mixed with 2 L (liters) of water in such a manner that the total amount became 4 L, thereby preparing a mixture A in a uniform slurry state. Next, the mixture A was put into a pressure-resistant air-tight vessel with a capacity of 8 L, and hydrothermal synthesis was carried out at 120° C. for 1 hour. Next, a precipitate, which was obtained, was washed with water, and a precursor A of an electrode active material in a cake shape was obtained.

Next, 75 g (in terms of a solid content) of the precursor A of the electrode active material and 10 g of polyvinyl alcohol were dissolved in 100 g of water to prepare an aqueous polyvinyl alcohol solution, and the aqueous polyvinyl alcohol solution was put into a ball mill that was filled with 250 g of zirconia balls having a diameter of 5 mm, and the mixture was mixed for 12 hours, thereby preparing uniform slurry A.

Next, the slurry A was dried in the atmospheric atmosphere at 180° C., and the resultant dried material was calcined under a nitrogen atmosphere at 250° C. for 1 hour, thereby preparing a calcined component A. In addition, the calcined component A was pulverized by using an agitating mortar, and then, the resultant pulverized component A was baked under a nitrogen atmosphere at a baking temperature of 800° C. for 30 minutes, thereby obtaining electrode material primary particles A including electrode active material primary particles that include LiFePO₄ and have an olivine structure, and a carbonaceous film that covers the surface of the electrode active material primary particles. In addition, the average particle size of the electrode material primary particles A was 600 μm.

In addition, electrode material primary particles B, which include electrode active material primary particles that include LiFePO₄ and have an olivine structure, and a carbonaceous film that covers the surface of the electrode active material primary particles, were obtained by the same method as in the electrode material primary particles A except that a ball mill filled with 300 g of zirconia beads having a diameter of 1 mm was used instead of the ball mill filled with 250 g of zirconia balls having a diameter of 5 mm, and baking was carried out at a baking temperature of 750° C. instead of baking at the baking temperature of 800° C. In addition, the average particle size of the electrode material primary particles B was 350 μm.

The electrode material primary particles A and the electrode material primary particles B were mixed in a mixing ratio illustrated in Table 1, thereby preparing electrode materials of Examples 1 to 5, and electrode materials of Comparative Examples 1 to 5.

TABLE 1

| | Primary particles |
|---|---|
| | A:Primary |
| | particles B |
| | Mass ratio |
| Example 1 | 50:50 |
| Example 2 | 40:60 |
| Example 3 | 30:70 |
| Example 4 | 60:40 |
| Example 5 | 70:30 |
| Comparative | 0:100 |
| Example 1 | |
| Comparative | 95:5 |
| Example 2 | |
| Comparative | 5:95 |
| Example 3 | |
| Comparative | 100:0 |
| Example 4 | |
| Comparative | 50:50 |
| Example 5 | |

(Preparation of Lithium Ion Secondary Battery)

The Electrode material of Example 1, polyvinylidene fluoride (PVdF) as a binder, and acetylene black (AB) as a conductive auxiliary agent were mixed in amass ratio of 90:5:5, and N-methyl-2-pyrrolidinone (NMP) as a solvent was added to the resultant mixture so as to provide flowability, thereby preparing slurry. Next, the slurry was applied onto aluminum (Al) foil having a thickness of 15 gm, and was dried. Then, the aluminum foil onto which the slurry was applied was compressed at a pressure of 600 kgf/cm², thereby preparing a positive electrode of a lithium ion secondary battery.

With respect to the positive electrode of the lithium ion secondary battery, a lithium metal was disposed as a negative electrode, and a separator formed from porous polypropylene was disposed between the positive electrode and the negative electrode, thereby obtaining a member for a battery. On the other hand, lithium hexafluorophosphate (LiPF₆) was dissolved in a mixed solution, which was obtained by mixing ethylene carbonate (EC) and ethyl methyl carbonate (EMC) in a volume ratio of 1:1, in such a manner that a concentration became 1 mol/dm³, thereby adjusting a nonaqueous electrolyte solution. Next, the member for a battery was immersed in the nonaqueous electrolyte solution, thereby preparing a lithium ion secondary battery of Example 1.

In addition, lithium ion secondary batteries of Examples 2 to 5, and lithium ion secondary batteries of Comparative Examples 1 to 5 were prepared in the same manner as in the lithium ion secondary battery of Example 1 except that the electrode materials of Examples 2 to 5 and the electrode materials of Comparative Examples 1 to 5 were used instead of the electrode material of Example 1.

Evaluation results of the electrode materials and the lithium ion secondary batteries of Examples 1 to 5 and Comparative Examples 1 to 5 are shown in Table 2.

TABLE 2

| | Specific surface | Specific surface | Number of | Number of | Number ratio of | | Capacity |
|---|---|---|---|---|---|---|---|
| | area of electrode | area of electrode | primary particles | primary particles | primary particles | | retention |
| | material primary | material primary | of 400 nm to | of 300 nm to | in accordance | Output | rate at 300^{th} |
| | particle A | particle B | 900 nm | 400 nm | with particle | DCR | cycle |
| | m²/g | m²/g | (A) | (B) | size B/A | Ω · mg | % |
| Example 1 | 8.9 | 10.8 | 14 | 78 | 5.6 | 488 | 80 |
| Example 2 | 8.9 | 10.8 | 10 | 78 | 7.8 | 472 | 80 |
| Example 3 | 8.9 | 10.8 | 9 | 95 | 10.6 | 451 | 76 |
| Example 4 | 8.9 | 10.8 | 15 | 65 | 4.3 | 501 | 83 |
| Example 5 | 8.9 | 10.8 | 13 | 51 | 3.9 | 511 | 83 |
| Comparative | — | 10.8 | 5 | 82 | 16.4 | 426 | 67 |
| Example 1 | | | | | | | |
| Comparative | 8.9 | 10.8 | 15 | 8 | 0.5 | 698 | 83 |
| Example 2 | | | | | | | |
| Comparative | 8.9 | 10.8 | 0 | 21 | — | 552 | 71 |
| Example 3 | | | | | | | |
| Comparative | 8.9 | — | 0 | 18 | — | 729 | 85 |
| Example 4 | | | | | | | |
| Comparative | 10.8 | 13.5 | 2 | 124 | 62.0 | 329 | 65 |
| Example 5 | | | | | | | |

Results

In the lithium ion secondary batteries of Examples 1 to 5 which were prepared by using an electrode material in which a value of B/A was 3 to 12, A representing the number of the first electrode material primary particles having a particle size in a range of 400 nm to 900 nm, and B representing the number of the second electrode material primary particles having a particle size in a range of equal to or greater than 300 nm and less than 400 nm during observation of a visual field of the electrode material in a range of 3.0 μm×2.4 μm at a magnification of 30,000 times by using a scanning electron microscope, the output DC resistance (DCR) was low, and the capacity retention rate at the 300^{th} cycle was high.

On the other hand, in the lithium ion secondary battery of Comparative Example 2 which was prepared by using an electrode material in which the value of B/A was less than 3, the capacity retention rate at the 300^{th} cycle was high, but the output DC resistance (DCR) was also high.

In addition, in the lithium ion secondary batteries of Comparative Example 1 and 5 which were prepared by using an electrode material in which the value of B/A was greater than 12, the output DC resistance (DCR) was low, but the capacity retention rate at the 300^{th} cycle was also low.

In addition, in the lithium ion secondary batteries of Comparative Examples 3 and 4 which did not include the first electrode material primary particles having a particle size in a range of 400 nm to 900 nm, the capacity retention rate at the 300^{th} cycle was high, but the output DC resistance (DCR) was also high.

According to this, when using an electrode material in which the value of B/A was 3 to 12, A representing the number of the first electrode material primary particles having a particle size in a range of 400 nm to 900 nm, and B representing the number of the second electrode material primary particles having a particle size in a range of equal to or greater than 300 nm and less than 400 nm during observation of a visual field of the electrode material in a range of 3.0 μm×2.4 μm at a magnification of 30,000 times by using a scanning electron microscope, it could be seen that it is possible to obtain a lithium ion secondary battery in which the DC resistance (DCR) is low and which is capable of maintaining a high capacity retention rate for a long period of time.

What is claimed is:

1. An electrode material comprising:
electrode material primary particles including electrode active material primary particles which include LiFeₓM_{y}Mn_{1-x-y}PO₄ (provided that, M represents one or more kinds selected from the group consisting of Mg, Ca, Co, Sr, Ba, Ti, Zn, B, Al, Ga, In, Si, Ge, and a rare earth element, and relationships of and 0≦y≦0.14 are satisfied) and have an olivine structure, and a carbonaceous film that covers the surface of the electrode active material primary particles,
wherein the electrode material primary particles include first electrode material primary particles having a particle size in a range of 400 nm to 900 nm, and second electrode material primary particles having a particle size in a range of equal to or greater than 300 nm and less than 400 nm, and
in a case where the number of the first electrode material primary particles is set as A and the number of the second electrode material primary particles is set as B when observing a visual field of the electrode material in a range of 3.0 μm×2.4 μm at a magnification of 30,000 times by using a scanning electron microscope, a value of B/A is 3 to 12.

2. The electrode material according to claim 1,
wherein the value of B/A is 5 to 11.

3. The electrode material according to claim 1,
wherein the value of B/A is 3 to 8.

4. The electrode material according to claim 1, not including electrode material primary particles having a particle size of 1100 nm or greater.

5. A method of manufacturing an electrode material according to claim 1, comprising:
mixing two or more kinds of electrode material primary particles having average particle sizes different from each other.

6. An electrode containing the electrode material according to claim 1.

7. A lithium ion secondary battery comprising:
the electrode according to claim 6 as a positive electrode.

8. The lithium ion secondary battery according to claim 7,
wherein DC resistance (DCR) on an output side is 520 Ω·mg or less, and a capacity retention rate at a 300^{th} cycle is 75% or greater.
